(19) United States
(12) Patent Application Publication
(10) Pub. No.: US 2010/0325865 A1
(43) Pub. Date: Dec. 30, 2010

(54) TOOL TO INSTALL A PIPE INTO A MANHOLE

(76) Inventor: Rick Jeffers, Dahlonega, GA (US)

Correspondence Address: Rick Jeffers, 446 White Pine Dr., Dahlonega, GA, 30533, US

(21) Appl. No.: 12/628,988

(22) Filed: Dec. 1, 2009

Related U.S. Application Data
(60) Provisional application No. 61/220,016, filed on Jun. 24, 2009.

(51) Int. Cl. B23P 11/02; B23P 19/04

(52) U.S. Cl. 29/450; 29/243.518; 29/281.6

(57) ABSTRACT

A tool to install a pipe into a manhole includes: an expansion band adapted to be inserted inside the boot; a bracket connected to the expansion band; an expansion link, adapted to urge the expansion band to expand; a removable bolt to releasably connect the expansion link to the bracket; and a nut to releasably retain the bolt to the expansion link and the bracket. The expansion link urges expansion of the expansion band so that the pipe may be installed into the rubber boot on a manhole, and then the nut and bolt are removed, thereby releasing the tool from the manhole.

### RELATED APPLICATIONS

The present application claims benefit of priority from U.S. Provisional Application No. 61/220,016, filed Jun. 24, 2009, which is incorporated herein by reference in its entirety.

### BACKGROUND OF THE INVENTION

The present invention generally relates to construction tools, and more specifically, to a tool to install a pipe into a manhole.

The rubber boot that is connected to a manhole is smaller than the pipe that may be installed.

The typical system requires a person to expand the rubber boot with screwdrivers or other prying devices, while trying to install the pipe into the rubber boot at the same time, which may be difficult, and time consuming.

As can be seen, there is a need for a manhole installation tool.

### SUMMARY OF THE INVENTION

In one aspect of the present invention, a tool for installing a boot onto a pipe includes: an expansion band adapted to be inserted inside the boot; and an expansion link releasably connected to the expansion band, adapted to urge the expansion band to expand; wherein the expansion link urges expansion of the expansion band so that the boot may be installed onto the pipe, and then the expansion link releases from the expansion band so that the tool may be removed.

In another aspect of the present invention, a tool for installing a pipe into a manhole includes: an expansion band adapted to be inserted inside the boot; a bracket connected to the expansion band; an expansion link, adapted to urge the expansion band to expand; a removable bolt to releasably connect the expansion link to the bracket; and a nut to releasably retain the bolt to the expansion link and the bracket; wherein the expansion link urges expansion of the expansion band so that the boot may be installed onto the manhole, and then the nut and bolt are removed, thereby releasing the tool from the manhole.

In yet another aspect of the present invention, a method for installing a boot onto a pipe includes: releasably connecting an expansion link to an expansion band; inserting the expansion band into the boot; utilizing the expansion link to urge the expansion band to expand, thereby expanding the boot; inserting the boot onto the pipe; sliding the expansion band out of the boot; releasing the expansion link from the pipe; and removing the expansion band.

These and other features, aspects and advantages of the present invention will become better understood with reference to the following drawings, description and claims.

### BRIEF DESCRIPTION OF THE DRAWINGS

FIG. 1 depicts an embodiment of the present invention to be utilized to expand a boot;

FIG. 2 depicts the embodiment of FIG. 1 being used to install a pipe; and

FIGS. 3A, 3B, 3C, 3D, 3E, 3F, 3G and 3H depict embodiments of steps utilized to install a pipe according to the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention generally provides a tool that expands the rubber boot on a manhole so a pipe can be connected.

An embodiment of the present invention may help connect a pipe to a manhole by expanding the rubber boot to a larger diameter than the pipe being installed. It expands the rubber boot larger than the diameter of the pipe and holds it in the expanded position for easier installation of pipe. The boot may be a rubber, latex, polymer, material, or another elastic material to be used as a gasket or lip for the top end of the pipe.

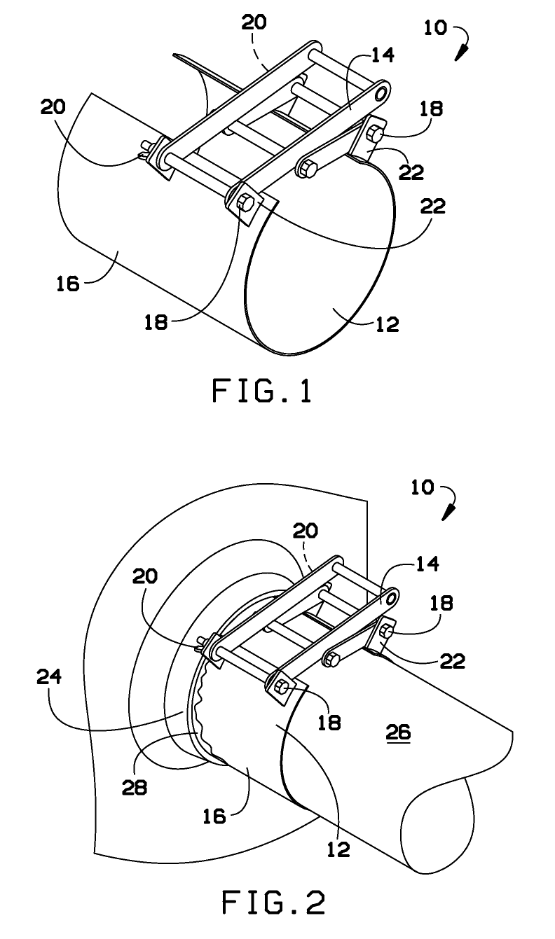

As depicted in FIG. 1, an embodiment 10 of the present invention may include an expansion tool 12, having an expansion link 14 to urge open an expansion band 16. The expansion link 14 may have two levers, attached by a hinge to an end of a first lever and a point near or below (closer to the band 16) of the mid-point of the second lever. The first lever rotates against the second lever, to either pull the expansion band 16 closed or apply a force to urge the expansion band 16 open. The link 14 attaches to the expansion band 16 with two upright brackets 22, each of which has a bolt 18, and a nut 20. The expansion band 16 is connected to the upright brackets 22, and the expansion link 14 connects to one or both of the upright brackets 22 with bolts 18 so as to allow movement on the bolts 18 that are releasably secured by the nuts 20, such as wingnuts.

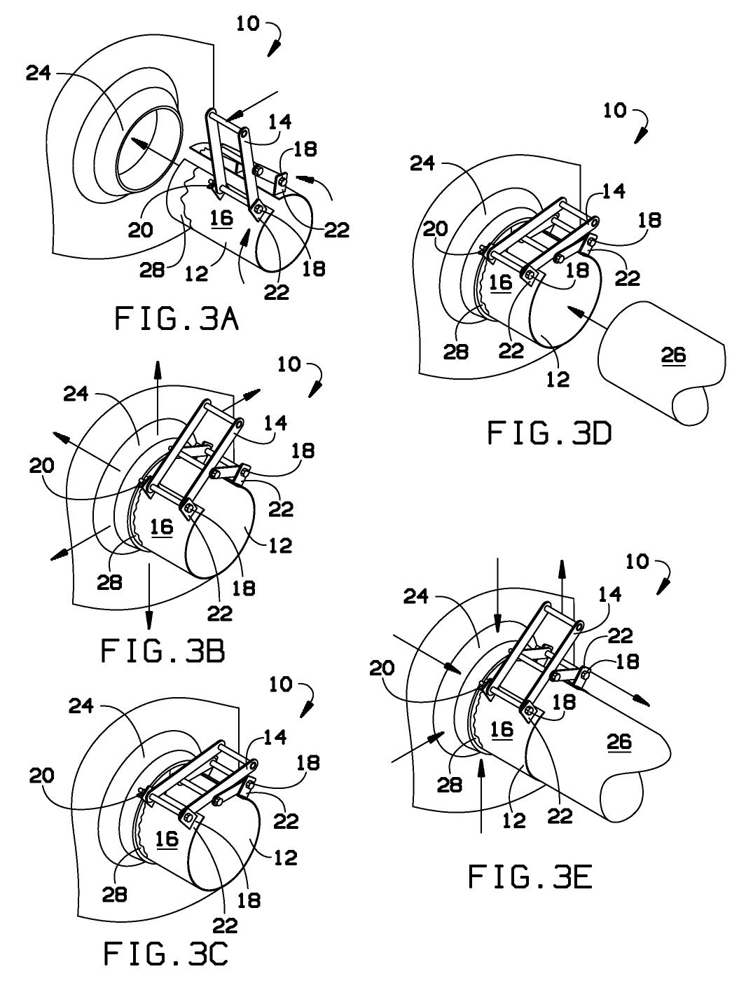

FIG. 2 depicts an embodiment 10 being utilized to expand a rubber boot 24 to accept a pipe 26. Lubricant 26 may be applied to the rubber boot 24 to ease insertion of the expansion tool 12 and pipe 26.

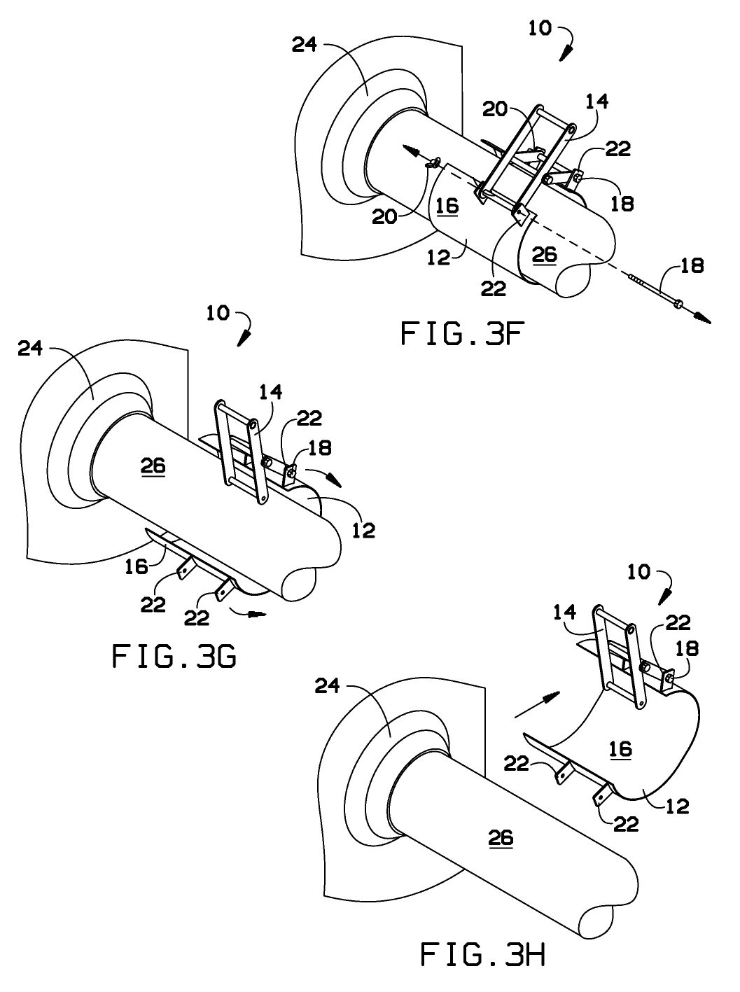

FIGS. 3A, 3B, 3C, 3D, 3E, 3F, 3G and 3H depict the steps utilized in an embodiment of the present invention. The steps are not necessarily performed in the precise order listed.

To use an embodiment of the device, first a person collapses the tool by pushing the expansion link 14 in the opposite direction of the motion that is required to expand the tool, and then places the tool into the rubber boot (FIG. 3A). Push the expansion link 14 in the direction required to expand the expansion band 16 (FIG. 3B). The expansion link 14 is connected by bolt 18, and applies an outward pressure to the upright bracket 22 that is connected to the expansion band 16, causing the upright brackets to become spread further apart that expands the expansion band 16, which expands the manhole rubber boot (FIG. 3C). The device is locked in the expanded position until the pipe 28 has been slid through the expanded device into the manhole (FIG. 3D). The tool is collapsed by lifting upwards on the expansion link 14. The device is pulled out of the rubber boot by sliding it along the pipe (FIG. 3E). The device is removed from the newly installed pipe by pulling the bolt 18 out of the expansion link 14 (FIG. 3F) allowing the expansion link 14 to be separated from the upright bracket 22 (FIG. 3G, FIG. 3H).

In an embodiment, the expansion band may be made from thin light weight material that is strong enough to spread the rubber boot, but flexible enough to spread apart so it can be removed from the pipe by pulling it off in a horizontal direction.

In an alternative embodiment, the expansion link can be used with expansion bands of different sizes to accommodate different size boots.

It should be understood, of course, that the foregoing relates to exemplary embodiments of the invention and that modifications may be made without departing from the spirit and scope of the invention as set forth in the following claims.

We claim:

1. A tool for installing a pipe into a boot, comprising:
an expansion band adapted to be inserted inside the boot; and
an expansion link releasably connected to the expansion band, adapted to urge the expansion band to expand;
wherein the expansion link urges expansion of the expansion band so that the pipe may be installed into the boot, and then the expansion link releases from the expansion band so that the tool may be removed.

2. The tool of claim 1, further comprising:
a bracket connected to the expansion band; and
a removable bolt to releasably connect the expansion link to the bracket;
wherein, after the pipe is installed onto the boot, the bolt is removed, thereby releasing the expansion link from the expansion band.

3. The tool of claim 2, further comprising:
a nut to releasably retain the bolt to the expansion link and the bracket.

4. The tool of claim 1, wherein the pipe is a manhole, and the boot is an elastic material to be installed onto the top of the manhole.

5. The tool of claim 1, wherein the expansion link includes a first lever and a second lever, an end of the first lever rotatably attached to the second lever so that, when the first lever rotates relative to the second lever in a first direction, the expansion link urges the expansion band to expand, and when the first lever rotates relative to the second lever in a second direction, the expansion link urges the expansion band to close.

6. A tool for installing a pipe into a manhole having a boot, comprising:
an expansion band adapted to be inserted inside the boot;
a bracket connected to the expansion band;
an expansion link, adapted to urge the expansion band to expand;
a removable bolt to releasably connect the expansion link to the bracket; and
a nut to releasably retain the bolt to the expansion link and the bracket;
wherein the expansion link urges expansion of the expansion band so that the pipe may be inserted inside the boot, and then the nut and bolt are removed to release the tool, thereby installing the pipe into the manhole

7. A method for installing a pipe into a boot, comprising:
releasably connecting an expansion link to an expansion band;
inserting the expansion band into the boot;
utilizing the expansion link to urge the expansion band to expand, thereby expanding the boot;
inserting the pipe onto the boot;
sliding the expansion band out of the boot;
releasing the expansion link from the pipe; and
removing the expansion band.

8. The method of claim 7, further comprising:
utilizing a removable bolt to releasably connect the expansion link to the expansion band; and
removing the bolt from the expansion link after the pipe is installed into the boot, thereby releasing the expansion link from the expansion band.

9. The method of claim 8, further comprising:
providing a tool having the expansion band, the expansion link, and the bolt; and
utilizing the tool to install the pipe into the boot and removing the bolt to release the tool from the pipe.

10. The method of claim 7, wherein the pipe is a manhole, and the boot is an elastic material to be installed onto the top of the manhole.
